(19) United States
(12) Patent Application Publication
(10) Pub. No.: US 2017/0116608 A1
(43) Pub. Date: Apr. 27, 2017

(54) SYSTEM AND METHOD FOR PAYMENT PROCESSING USING CRYPTO CURRENCIES

(71) Applicant: Align Commerce Corporation, San Francisco, CA (US)

(72) Inventors: Marwan Forzley, Sausalito, CA (US); Aldo Mario Eduardo S. Carrascoso, Daly City, CA (US)

(21) Appl. No.: 14/919,909

(22) Filed: Oct. 22, 2015

(51) Int. Cl. G06Q 20/40; G06Q 40/04

(52) U.S. Cl. CPC G06Q 20/4014; G06Q 40/04; G06Q 2220/00

(57) ABSTRACT

A payment processor receives currency information and identification information. The currency information comprising a payer fiat-currency and a payee fiat-currency and the identification information comprises information verifying the identify of a payer and a payee. The payment processor utilizes the currency information and the identification information to determine a transaction restriction level and verifies that the identification information meets the threshold for the transaction restriction level. The payment processor receives payment in the payer fiat-currency and initiates a transaction to convert the payer fiat-currency amount into a crypto-currency amount. The payment processor converts the crypto-currency amount into the payee fiat-currency. The payment processor initiates a transfer of the payee fiat-currency amount to the payee.

### FIELD OF THE INVENTION

The present invention is related to the field of payment processing using cryptocurrencies.

### BACKGROUND OF THE INVENTION

Currencies may be transferred from a payer to a payee for various reasons. A buyer may purchase goods or services from a merchant in person, via telephone or through an Internet web site. A merchant or business may be paying a supplier, employees, sales people, consultants, or others. They may also be issuing refunds or rebates to customers or suppliers, or making payments as part of an affiliate program with another business or individual. Businesses may be paying salaries to employees or consultants on a reoccurring or one-time basis. There are a number of other situations where an individual will be simply transferring currencies to an associate or family member in another country. Payments may be small or large and completion of the payment may be required quickly or to be completed at a specific time, for example, at the end of the business day in a particular time zone. Payments may be made in the same or different currencies.

Other than cash payments, there exist a number of methods of making payments including checks, credit or debit card accounts, wire transfers, and many other means. Transaction fees are typically charged by the financial institutions and these fees can be applied to the payer, the payee, or both. In the case where the payer pays in one national or fiat-currency and the payee wishes to receive payment in another fiat-currency, the fiatexchange rate may also represent another type of fee. Fees can be substantial and, in the case of transferring small amounts, could represent a significant amount of the payment or even exceed it.

Some entities such as companies employing many independent contractors must pay their employees a relatively small amount monthly. The employer often is assessed a per transaction fee for each payment and each independent contractor must often also pay a transaction fee to receive a payment. If the fee is based on the transaction rather than the amount transferred and the amount is small, the fees can amount to a significant portion of the total payment. An extreme case is organizations who deal in micropayments that may be less than $1, $5, or $20 depending on the case. Even very small transaction fees may exceed the amount of the payment, making these types of business models unfeasible.

The time to make a payment can vary from being almost instantaneous to days, to months for some types of international transfers. Reporting and confirmation of payments can also be an issue with neither the payer nor the payee completely sure who sent a payment, what fees and exchange rates were charges, and if it was actually received. Should a payment be delayed or the received amount not match the expected amount, it can be difficult and time-consuming working with the banks and payment processors to determine what has happened.

Digital or crypto-currencies have been developed that can be used to provide payment for goods and service and be used by both payers and payees and be used for both domestic and international transfers. Crypto-currencies are a medium of exchange designed around securely exchanging information and value. A crypto-currency can be either centralized or decentralized. Crypto-currencies often require a digital wallet or exchange in order to make or receive payments, and exchanging fiat-currencies with crypto-currencies can be quite difficult.

Despite the benefits of crypto-currencies, some applications have been criticized as not complying with government regulations regarding money transfers. These regulations include Anti-Money Laundering (AML) policies and Know-Your-Customer (KYC) requirements. Crypto-currencies transactions have been associated with criminal activities and this causes legitimate businesses and banks to avoid their use. There is a lack of trusted crypto-currency exchanges that businesses are willing to use. In particular, public companies or companies subject to regulatory or audit requirements may be prohibited from using exchanges that do not comply with certain government regulations.

The exchange rate of crypto-currencies to fiat-currencies has also been extremely volatile which has lead to speculation and some holders of crypto-currencies experiencing large gains or losses. Due to this, many businesses and individuals are reluctant to hold crypto-currencies or to use them as a currency for business transactions.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF SUMMARY

In one embodiment of the invention a payment processor receives currency information and identification information. The currency information comprising a payer fiat-currency and a payee fiat-currency, and identification information comprising information verifying the identify of a payer and a payee. The payment processor utilizes the currency information and the identification information to determine a transaction restriction level. The payment processor verifies that the identification information meets a threshold for the transaction restriction level. The payment processor receives payment in the payer fiat-currency and initiates a transaction to convert the payer fiat-currency amount into a crypto-currency amount. The payment processor converts the crypto-currency amount into the payee fiat-currency and initiates a transfer of the payee fiat-currency amount to the payee.

In some embodiments the payment processor determines criteria to be used to select the crypto-currency and selects the crypto-currency.

In another embodiment of the invention a payment processor receives currency information and identification information. The currency information comprises a payer fiat-currency and a payee fiat-currency. The identification information comprises information verifying the identify of a payer and a payee. The payment processor utilizes the currency information and the identification information to determine a transaction restriction level. The payment processor verifies that the identification information does not meet a threshold for the transaction restriction level and augments the identification information to meet the threshold for the transaction restriction level. The payment processor receives payment in the payer fiat-currency and initiates a transaction to convert the payer fiat-currency amount into a crypto-currency amount. The payment processor converts the crypto-currency amount into the payee fiat-currency and initiates a transfer of the payee fiat-currency amount to the payee.

The payment processor may augment the identification information by verifying the identity of the payer or payee with a portion of information provided by the payer and a portion of information provided by the payee.

An a further embodiment of the invention a payment processor receives currency information and identification information. The currency information comprises a payer fiat-currency and a payee fiat-currency. The identification information comprising information comprising a payer trusted level and a payee trusted level. The payment processor utilizes the currency information and the identification information to determine a transaction restriction level. The payment processor verifies that the payer trusted level and the payee trusted level meet a threshold for the transaction restriction level. The payment processor receives payment in the payer fiat-currency and initiates a transaction to convert the payer fiat-currency amount into a crypto-currency amount. The payment processor converts the crypto-currency amount into the payee fiat-currency and initiates a transfer of the payee fiat-currency amount to the payee.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an overview of a financial transaction using an embodiment of the invention.

FIG. 2 shows an overview of a payer or payee being verified by the system

FIG. 3 shows an overview of an embodiment of a level 1 verification.

FIG. 4 shows an overview of an embodiment of a level 2 verification.

FIG. 5 shows an overview of an embodiment of a level 3 verification.

FIG. 6 shows a detailed embodiment of paying an invoice and sending an invoice.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Embodiments of the invention relate to trusted currency transactions involving two parties who are customers of a payment processor. Typically, at least one party will be a business. The other party may be a business or an individual. One party of the transaction is the payer, who is making a payment. The other party is the payee, who is receiving a payment. Transactions require both a payer and a payee. Transactions using embodiments of this invention may be initiated by either the payer or the payee. The payer may receive a request for payment and then respond by paying the specified amount or the payer can initiate a transaction to send or pay money to a payee. Similarly, the payee may receive money from a payer or may initiate a transaction to request or demand payment from the payee.

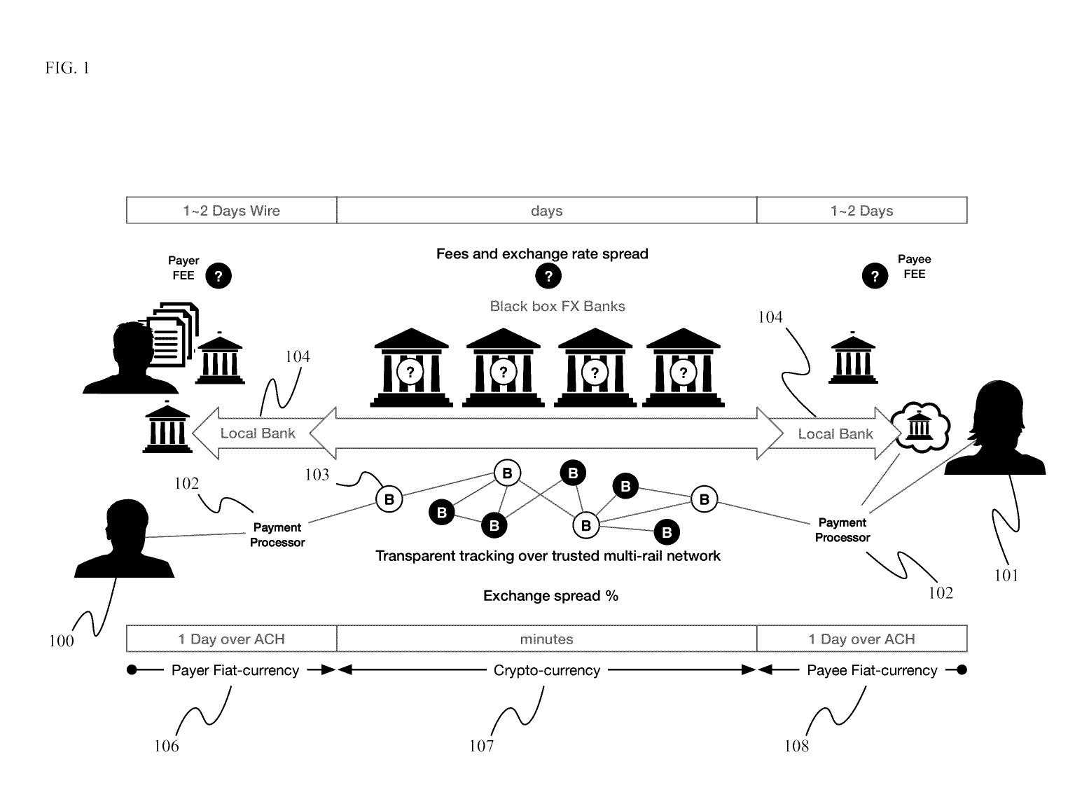

Referring to FIG. 1, the payer 100 may a shopper paying a merchant or a business paying a supplier. Often the payee 101 will be a supplier receiving a payment, an employee, or a consultant. A shopper may initiate a transaction by indicating a desire to purchase a good through a variety of mean such as a website, over the telephone, or through an e-mail or traditional, hard copy mail. A payer 100 such as an employer may initiate a single or multiple payments on a one-time or reoccurring basis in order to pay the salary of an employee or contractor. Payments to suppliers may also be on a one-time or reoccurring basis. A payee 101 such as a company selling goods may initiate an invoice transaction to demand payment for goods sold and delivered to the payer which may be an individual, another company, or another organization.

Besides the payer 100 and payee 101, parties involved in the transaction are one or more payment processors 102, one or multiple crypto-currency exchanges 103, and one or more banking institutions 104. The payment processor 102 acts as a coordinator for the transaction. The payment processor 102 is an entity, likely a company or organization, that is providing a service for facilitating the financial transaction between the payer 100 and payee 101. The payment processor 102 may be independent of the payer and payee, providing the service through a website, telephone, or in person. The payment processor 102 may also be the same entity as the payer 100 or payee 101, facilitating the financial transaction as well as sending or receiving currencies. They provide interfaces to the payer, payee, the crypto-currency exchanges 103, and the banking institutions 104. The payer and payee register with the payment processor to participate in financial transactions. The payment processor 102 coordinates with crypto-currency exchanges 103 to convert between fiat-currencies and crypto-currencies 107, and between different crypto-currencies. Banking institutions 104 may be used to accept payments from a payer in a fiat-currency of their choice 106 and to remit payments to a payee in the fiat-currency of their choice 108.

The transaction may not involve any good or service but may be a financial transfer to send funds from a payer 100 to a payee 101. The payer and payee may be in the same or different countries. The payer and the payee may use the same or different fiat-currencies, or may use one of a variety of crypto-currencies 107.

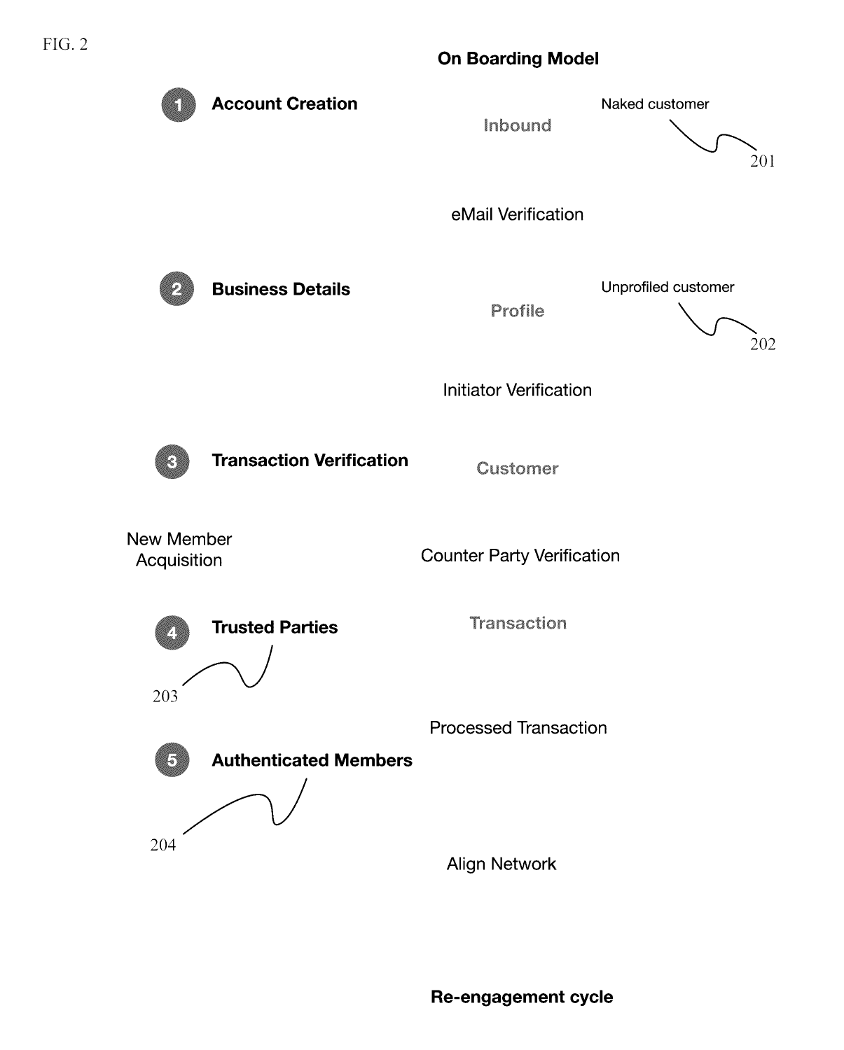

Referring to FIG. 2, transactions conducted using embodiments of the invention may involve the identities of one or both parties verified in compliance with Anti-Money Laundering (AML) policies and Know-Your-Customer (KYC) requirements or similar requirements in the jurisdiction of the payer or the payee or both jurisdictions. Transactions may also be compliant with similar international regulations. The payment processor classifies payees and payers as new, or naked customers 201, unprofiled customers 202, transacting customers 203, or authenticated members 204. A naked customer 201 is a payee or payer that has registered with the payment processor to make or receive a payment. The naked customers 201 have supplied only minimal, unverified information to identify themselves such as an e-mail address, name, telephone number, or other information or combination of information to allow the payment processor to contact them. Typically, the registration will be done on the payment processor's website involving a user name and password for authentication, though this could also be done via e-mail, telephone or other means. It may also be done on a third party website that the payment processor has access to, such as a bank, financial institution, credit card company, or the payee's or payer's website. The payment processor may provide APIs (application program interface) to enable these third parties to securely interface with the payment processor.

The process of registering as a naked customer 201 creates an account with the payment processor changing their classification to being an unprofiled customer 202. An unprofiled customer 202 is then prompted to enter additional identification, business, and banking information to enable the payment processor and banking institutions to access their financial accounts to withdraw or deposit money. This information may include their country of residence, bank account and routing information, crypto-currency wallet address, credit or debit card information, email address, home or business address, telephone number and other information as required to make a financial transaction. At this point the customer becomes a transacting customer 203 and may send or receive fiat-currency or crypto-currency transactions. Since the identify of the transacting customer 203 has not yet been verified, there may be limitations on the transaction they are permitted to do. They may be limited to the number of transactions, the countries they can send or receive money with, be limited to transactions below a certain value, or may only be able to send or receive but not both. Restrictions on transactions below a certain value may be measured on a per transaction basis or based on the total value of transactions over a period of time. For example, a transacting customer 203 may be limited to transactions below $2,000 for each transaction and no more than $10,000 within a month.

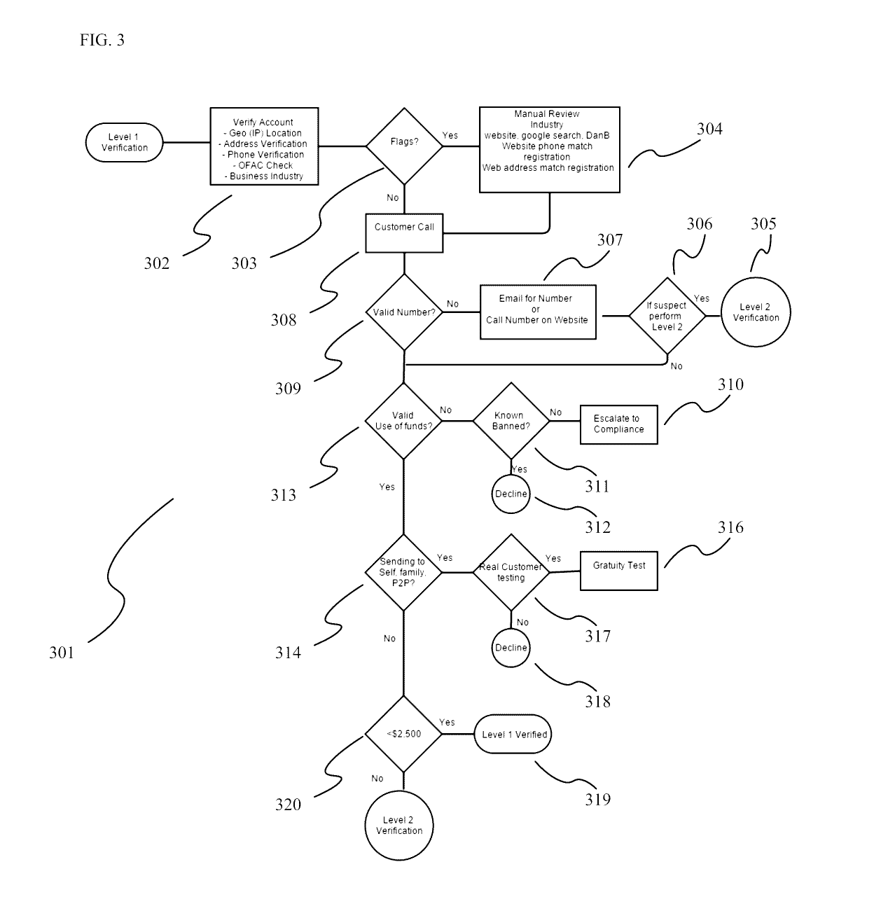

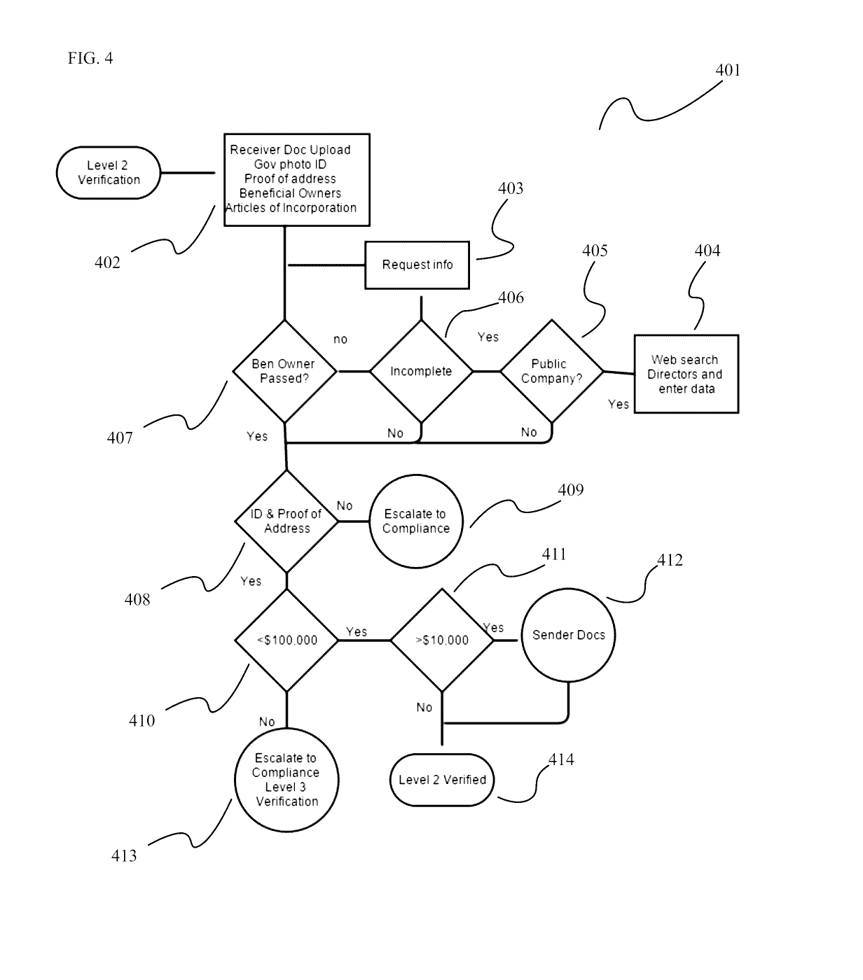

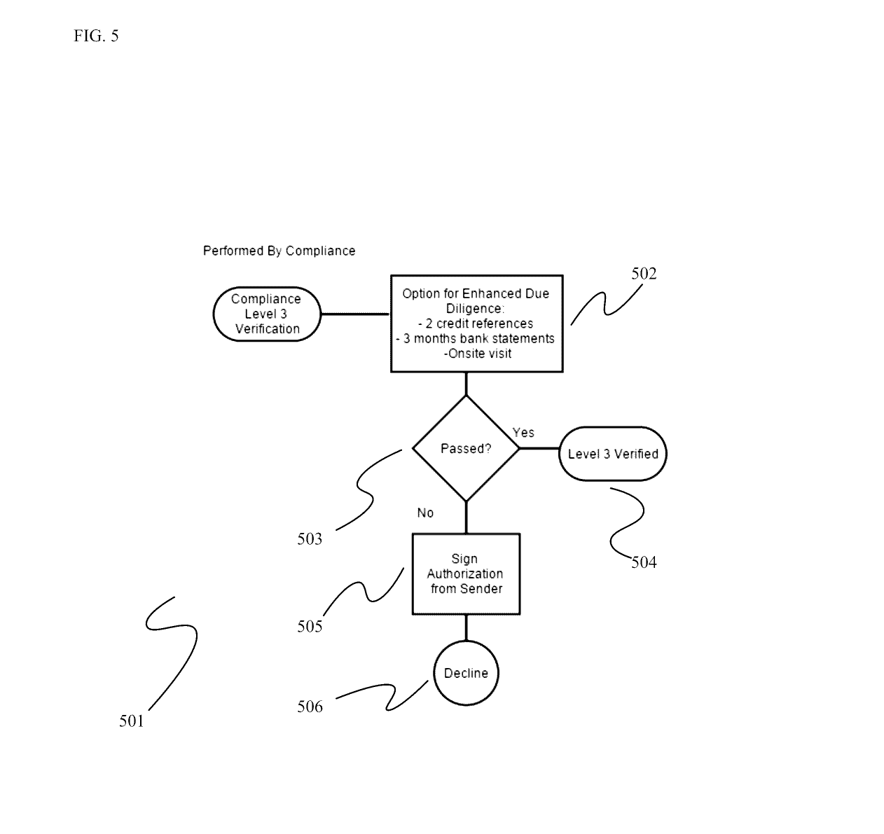

Referring to FIG. 3, in order to comply with the relevant government AML, KYC, and other regulations the payment processor will be required to verify the identity of the payer or payee. For some transactions, especially for large amounts of money, both may have to be verified. Verification can be done in different levels depending on the amount of money involved or other criteria as set out in the regulations. For small amounts it may be sufficient to do a level 1 301 verification that verifies data such as the location of the IP address, address of the business, location of the phone number, business industry databases, OFAC (Office of Foreign Assets Control), and similar checks. These can be done through a variety of methods including manual review by payment processor staff, querying of industry websites, internet search engines (Google, Bing, etc.), phone number directories, and calling the customer for verbal confirmation. Referring to FIG. 4, if the amount of money to be transacted exceeds a specified amount, such as $2,000 then further level 2 401 verification can be done. This may include review of government issued photo ID, proof of address, articles of incorporation, a review of SEC filings for public companies, and similar documents required for regulatory compliance. Referring to FIG. 5, for larger transfers a level 3 501 verification may be required, for example greater than $10,000, credit references, bank statements, and even onsite visits by the payment processor or their agents may be required. The transfer of larger amounts or other special circumstances may be required even more stringent checks.

Once a payee or payer has been verified to a certain level, they become authenticated members 204 at that level. Authenticated members are payers 100 or payees 101 who have been verified for transactions up to a specified amount or for transactions that meet certain criteria that could include source and destination country, and number of payees and other criteria. Future transactions involving authenticated members may be streamlined in that they can be initiated and completed without additional verification. This simplifies repeat and reoccurring payments between parties. It also simplifies transactions between authenticated members 204 that have not previously transacted. For example, if payer A has transacted with payee B, then A and B are both authenticated members. If payer C has transacted with payee D, then C and D are both authenticated members. Then if payer A wants to transfer money to payee D or payer C wants to transfer money to payee B, it can be done without account verification since all four parties are authenticated members. However, if any of the parties are only verified at level 1 and then want to make a larger, level 2 transaction, they may have to submit further information to be verified to the required level to complete the transaction.

FIG. 3 shows details of an example of level 1 verification 301 according to one embodiment of the invention. The level 1 verification starts with verification of the data input by an applicant (payer or payee) 302. The data can be verified through a variety of means including a Geo (IP) location, address verification, phone number verification, OFAC (Office of Foreign Assets Control) check, and a check of business or industry directories. (A Geo (IP) location is where the geographic location of an IP is queried from a public database.) The results of the check may raise flags 303 caused by results that meet predefined or dynamic criteria or exceed predefined or dynamic thresholds. Flags may also be raised when data is not available. If flags are raised, then a manual review 304 is required. This involves verifying the identity of the applicant on industry websites, Google searches, verifying a match of website registration with phone numbers and addresses, and any similar search to verify the identify of the applicant. Whether flags 303 are raised or not, often a customer agent working with or for the payment processor will call 308 the applicant to verify their telephone number or some of their contact or financial information. If the provided telephone number is not valid 309 the payment processor may attempt to confirm information by e-mailing the application or calling a telephone number listed on the website the applicant has provided 307. Based on the response of the applicant 306 a level 2 verification may be required 305. If the telephone number verification is completed a check is then done to determine if the application and transaction represents a valid use of funds 313 as determined by relevant government AML, KYC, and other regulations. If it is determined not to be a valid use of funds, then a check will be done to determine if the applicant has been banded from the service previously 311. If so then the application will be declined 312 and the applicant rejected. If the applicant has not previously been banned, then the application will be escalated to compliance for a manual check 310. Should the use of funds be valid 313 then a check is made to verify if the transfer is a non-business-to-business use such as sending funds to the applicant themselves, to family, or to another individual 314. If this is the case a test will be done to verify is the applicant is a real customer 317. If not, the applicant will be declined 318. If so a gratuity test will be performed 316. Once it is determined that this is a business transaction 314 then the value of the transaction will be evaluated against a threshold 320, for example $2,500. The exact limit may be chosen for business reasons by the payment processor or to ensure compliance with relevant government AML, KYC, and other regulations. If the transaction amount is less than the limit then level 1 verification is completed 319. If the amount exceeds the threshold 320, then level 2 verification is required.

FIG. 4 shows details of an example of level 2 verification 401 according to one embodiment of the invention. The applicant (payer or payee) is required to upload or provide more identification 402 such as government photo ID, proof of address, a list of beneficial owners of the company, articles of incorporation, or other similar identification. The payment processor may also request additional information 403 as required. A check of the beneficial owners 407 will be done and the information will be verified for completeness 406. If complete and the applicant is a public company 405 then a search will be done for the directors of the company and the data recorded by the payment processor 404. If the data is complete and the applicant is not a public company, then the ID and the address will be verified 408 and if the verification of ID and the supplied address fails then the application will be escalated to compliance 409. For transactions over a larger amount then for level 1 verification 320, for example, $100,000 410, as required for business reasons by the payment processor or to ensure compliance with relevant government AML, KYC, and other regulations, the transaction will be escalated to level 3 verification 413. If the transaction amount is greater than a lesser amount, such as $10,000 411, then level 2 verification is complete 414, otherwise more verification of applicant documents may be required.

FIG. 5 shows details of an example of level 3 verification 501 according to one embodiment of the invention. The applicant (payer or payee) may be required to provide further information 502 such as credit references and bank statements. Onsite visits may also be required for large transactions or transactions to of from some countries. If the verification of this information is successful 503 then level 3 verification 504 is complete. Otherwise further authorization 505 may be required from the applicant which may lead to the applicant being declined 506.

The payer initiates the transaction by accessing the payment processor as a naked customer and registering. The payer uses a computer or mobile device to access the website of the payment processor. This can be done by entering a URL in a web browser window, by clicking on a link in an e-mail, or by a variety of other well known means. The payer is prompted to create an account by entering a minimal amount of information that allows the payment processor to contact them. This could include a name, e-mail address, telephone number, and a password. The payer then becomes an unprofiled customer.

The payment processor will than send a confirmation e-mail to the e-mail address entered by the payer prompting them to enter further information about themselves and their company. The payer logs into the payment processor website and is presented with choices including to make a payment. This can be in response to an invoice being received or be unilaterally sending a payment to a payee.

The payer must then provide additional information concerning themselves or the business in order to verify their identify for regulatory compliance. This information may include the name of business, the address of their place of business as well as banking information such as the bank name, routing number, and account number from which payment will be received. It may also include a crypto currency wallet address, credit or debit card information, or other information to allow money to be transferred from the payer to the payment processor. This information may be verified to comply with regulations based on the amount of money to be transferred, the country of origin or destination, the frequency or number of transactions, or other parameters. At this point the payer is considered to be a transacting customer and can proceed with the payment.

The payer must also enter information regarding the payee. The information required may be similar or the same as for the payer. However, in embodiments of this invention the payer can input a minimal, but incomplete amount of information, complete information to verify the payee's identity, or any amount of information in between. Minimal information would be the minimum information required by the payment processor to be able to contact the payee to receive further information. Complete information is the information required to identify the payee and their business and comply will relevant government AML, KYC, and any other relevant regulations. Any information not provided by the payer will be provided by the payee afterwards and will be verified by the payment processor.

The payer, having provided partial or complete payee information, will then provide the amount to be paid, and whether they will pay in crypto-currency or fiat-currency. The amount to be paid in fiat-currency will often be the fiat-currency where the payer resides but may be another common fiat-currency such as US dollars or Euros.

Various options can also be made when making a payment that can be specified through a user interface at the payment processor's website. While individuals will likely only make a single payment at a time, business have more complex needs which could include paying multiple payees as part of the same transaction, making reoccurring payment such as salaries, electronic interfaces to accounting and financial software, and extensive reporting for internal or to fulfill government regulations regarding financial reporting and money laundering. For very small transactions such as micropayments where the fees are considered by the payer or payee to be significant, the payer, payee, or payment processor may choose to aggregate transactions before initiating the transfer at a later time. The payer may choose to not initiate transfers until the amount to be transferred exceed an amount or other criteria. They payee may choose not to accept transfer until the amount to be transferred exceed an amount or other criteria. The payment processor may provide information on fees, time required to make the transaction, information tied to Service Level Agreements (SLAs) or any other information before the payer commits to the transaction.

The payment processor will than use the payment information provided by the payer to transfer the required funds from the payer's bank or other payment source as indicated by the payer. This can be done in a variety of ways as known in the art including Automated Clearing House (ACH) transfers, electronic transfer, credit card payments, debit transfers, or drawing from an exiting payer account with the payment processor. If the payer is providing funds in a crypto-currency the payer will provide information to allow the payment processor to receive the funds which may include digital wallet addresses. The payment processor has the option of initiating the transfer immediately or may delay the payment until they have received the funds from the payer. The payment processor may initiate the transactions immediately or may also delay payment until certain criteria have been met such as receiving payment from the payer, making payment on a specified date, when the total amount to be transferred exceeds a certain amount, or any other criteria set by the payer or the payment processor.

If the payer is paying in a fiat-currency, the payment processor will then select a crypto-currency or several crypto-currencies for the transaction. There are a variety of crypto-currencies and this variety is expected to grow over time. Depending on parameters of the transaction one crypto-currency may provide an advantage over others such as lower fees, increased security, faster transfer, extensive reporting, government approval, or others. Payers or payees may also insist on the use of a single or multiple approved crypto-currencies. Parameters are numerous but could include the location of the payer and payee, type of transfer, amount to be transferred and others. The payment processor may choose a default crypto-currency or use these parameters to choose one. They may also select multiple crypto-currencies and present these choices to the payer and allow them to make the choice. Once a crypto-currency is chosen it will have associated protocols that govern the transfer, which may include information required, minimum and maximum amounts, and others.

Once the crypto-currency to be used for the transaction has been determined, the payment processor will select an exchange or multiple exchanges to convert the fiat-currency supplied by the payee to an equivalent amount of crypto-currency minus any fees that apply. The exchange may be a digital or cryptocurrency exchange, a private transaction, dark pool, or offline exchange. The exchange may report an exchange rate and any fees to be charged to the payment processor who may relay this information to the payer for approval or for informational purposes. The payment processor may use the exchange rate spread between buying and selling to receive a fee for the transaction. The payer may also supply a range of acceptable fees, a minimum amount of crypto-currency to be received by the payee after fees are paid, or other criteria and the payment processor may proceed without approval if the criteria are met.

The fiat-currency is successfully converted to crypto-currency by the exchange, which may be verified by a number of means including checking for errors, verifying success on the crypto-currency block chain, receiving an explicit indication of success from the exchange, or other means.

The crypto-currency amount is now converted by an exchange to an equivalent amount of the fiat-currency specified by or for the payee. Similarly to the conversion from payer fiat-currency to crypto-currency, this conversion from crypto-currency to payee fiat-currency may have its own set of criteria. Depending on parameters of the transaction, some exchanges may provide an advantage such as lower fees, increased security, faster transfer, extensive reporting, government approval, or others. Payers or payees may also insist on the use of a single or multiple approved crypto-currencies. Parameters are numerous but could include the location of the payer and payee, type of transfer, amount to be transferred and others. A default exchange may be used or an exchange may be chosen based on these criteria.

In order for a transaction to complete, both the payer and the payee must be authorized members that have provided the required information and had the information verified by the payment processor. In the present embodiment of the invention a payee who in not an authorized member will receive an e-mail or similar communication such as SMS, from the payer either directly or though the payment processor. The payee will be prompted to log into the payment processor's web site to supply additional information that hasn't been provided by the payer. This can include information regarding the business, the banking information of the payee, in fact, similar information required to identify the payee, compliant with government AML, KYC or other relevant national or international regulations. The information will be verified by the payment processor as in the case of the payer. The payee may also provide additional parameters such as the fiat-currency or crypto-currency of choice. In the case of micro-payments, the payee may specify a minimum amount of payment to receive in order to aggregate payments to lessen the impact of any fees charged by the payment processor or their local bank. The amount of information that must be provided and the verification required depends on the level of verification required which is dictated by government or international regulations or the business relationship between the payer and payee. For very small transactions, verification may not be required.

Once the identity of the payee has been verified to the level required by the parameters of the transaction, the payment processor will initiate the conversion from crypto-currency to the payee's fiat-currency and may receive the fiat-currency and use the payee's banking or deposit information to pay the crypto-currency to the payee. Alternatively, the payment processor may initiate the transfer of the payee fiat-currency directly to the payee from the exchange or through a third party using information identifying the payee.

The payment processor may then report information to the payer and payee including confirmation of the transfer completing successfully, exchange rates, fees, previously completed transfers, future scheduled transfers, taxes due, and other relevant information. Reporting may also be made to government bodies as required.

Transactions may be initiated by either the payer or the payee. In other embodiments of the invention the payee may register and issue an invoice or a demand for a payment. If the payer is not an authenticated member the payee will input a minimum amount of information for the payment processor to contact the payer, complete information regarding the payer, or incomplete information regarding the payer. The payer will receive an e-mail or similar communication such as SMS, from the payee either directly or though the payment processor. The payer will be prompted to log into the payment processor's web site to supply additional information that hasn't been provided by the payer. This can include information regarding the business, the banking information of the payer, information required to identify the payer, compliant with government AML, KYC or other relevant national or international regulations. The information will be verified by the payment processor. The payee may also provide additional parameters such as the fiat-currency or crypto-currency of choice. In the case of micro-payments, the payer may specify a minimum amount of payment to pay in order to aggregate payments to lessen the impact of any fees charged by the payment processor or their local bank.

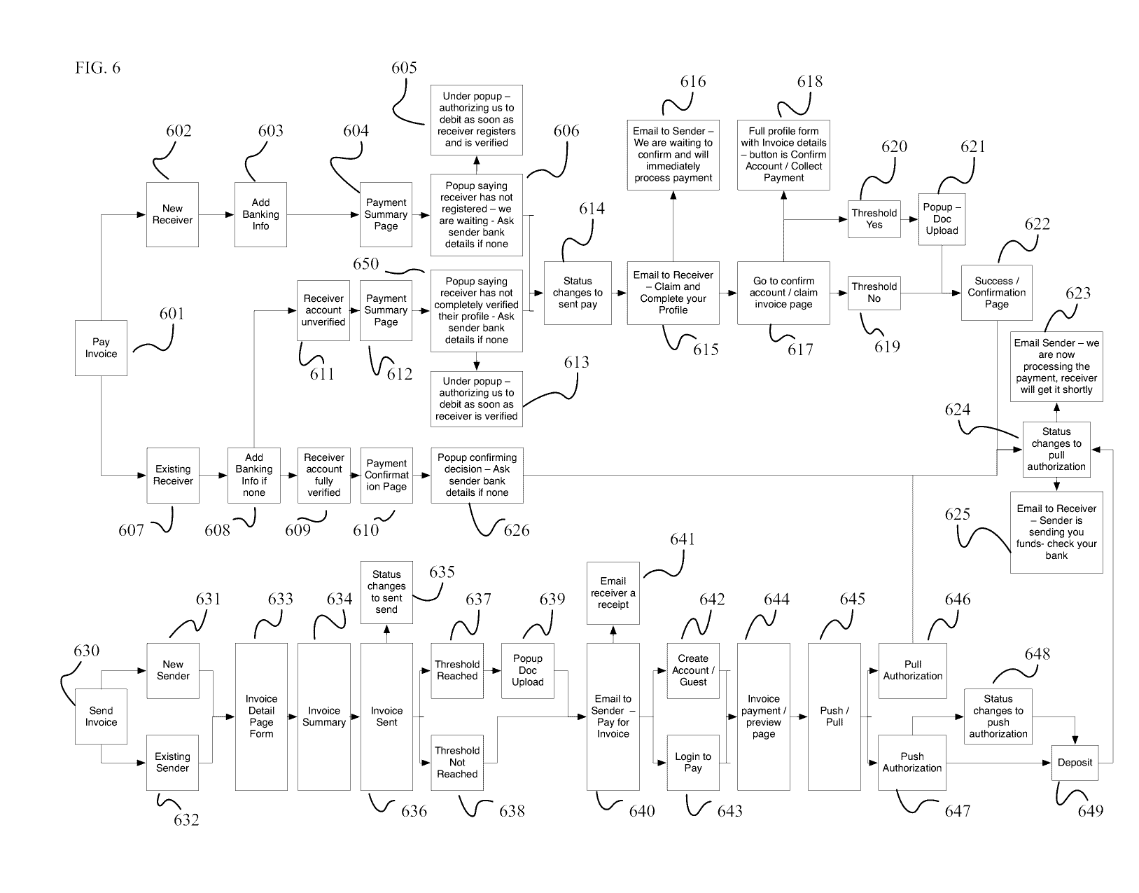

FIG. 6 shows details of an example of a system used to make a transaction made using a first embodiment of the invention. A transaction between a verified payer and a payee that has not previously used the payment processor starts when a payer wishes to pay a payee for a good or a service with the payer paying in a national, or fiat-currency of their choice and the payee receiving payment in a fiat-currency of their choice. The payer may be a shopper paying a merchant or a business that is paying a supplier, an employee, or a consultant. The payer and payee may be in the same or different countries. The transaction may not involve any good or service but may be a financial transfer to send funds from a payer to a payee.

A payer or sender, who has previously been verified and has conducted at least one transaction before starts the process by indicating through a user interface to pay an invoice 601. The invoice contains at least partial identification information for the payer and the payee and may include banking information to where the payment should be made. The process for a payee, or receiver is different for a new receiver 602 or an existing receiver 607 that has been verified. The payer initiates the paying of an invoice and indicates a payee or receiver of the funds. Typically, the payer will not know if the receiver is a new or existing client of the payment processor. If the receiver or payee 602 is new, then the payer is prompted to enter banking information 603 to the system to enable payment. The payer is then presented with a payment summary page 604 to enable them to verify the invoice payment details. The payer will then be informed that since the payee is new 606 that the transaction must wait until the payee or receiver is registered and verified. The payment processor will also be authorized to debit the payer's account as soon as the receiver registers and is verified 605. Similarly, if the receiver is an existing client 607 of the payment processor but has not been verified for the size or other characteristic of the transaction 611, the payer will still be presented with a payment summary page 612 but will then be informed that the receiver must be verified 650 and that the payment processor is authorized to debit the payer's account as soon as the receiver registers and is verified 613. Once the transaction is waiting for the receiver to be registered and verified or just verified, the status of the transaction is changed to “sent pay” 614. An email is sent to the receiver prompting them to complete their profile 615, to be registered and verified, in order to receive their payment. An email is also sent to the sender informing them that the payment processor is awaiting payee confirmation and that the payment will be processed 616. After receiving the email notification, the payee or receiver will log into the payment processor's website and be presented with a user interface 618 that allows them to confirm the information for their account and to claim the invoice amount 617. A final check of the transaction will be made to determine if the payer and payee are verified against the threshold for the transaction parameters. If the threshold is exceeded 620 then an additional popup window 620 will be presented to allow input of further information. If the threshold is not exceeded 619 the payee is then presented with a success/confirmation page 622.

If the payee is an existing receiver and has been fully verified 609 then the payer is presented with a payment confirmation page 610. Another popup window confirming the decision and prompting for any additionally required bank details 626 is displayed. Once this happens or the success/confirmation page 622 is displayed then the status of the transaction is changed to “pull authorization” 624 and a confirmation email is sent to the sender 623 indicating that the payee will soon receive the funds, and to the receiver 625 informing them to expect to receive funds shortly.

An an example of a payee sending an invoice 630 is similar in that the process differs for the case of an existing, new sender or payer 631, or an existing sender, or payer 632. The payee is presented with a user interface containing an invoice detail page from 633 that allows them to enter invoice data including the identity of the payer and banking information for both the payee or the payer. An invoice summary form 634 is then displayed to allow the sender or payee to review and confirm the information. The invoice is then sent 636 and any status updates to the payee 635 is also sent. A check is made as to whether a transaction threshold for is not exceeded 638 or is exceeded 637 and if the threshold is exceeded an additional form is displayed 639 to enable the upload and verification of additional documentation. An email is then sent to the payee 640 to prompt them to pay the invoice. The payee who created the invoice is also sent an email 641 as a receipt for the transaction. The payer may login to their existing account 643, or register for a regular or guest account 642. They are then presented with an interface to preview the invoice 644 and may then process and pay it 645. The status then changes to “push authorization” and the funds are transferred from the payer to the payee 649.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method of electronic commerce payments comprising;
a payment processor receiving currency information and identification information,
said currency information comprising a payer fiat-currency and a payee fiat-currency,
said identification information comprising information verifying the identify of a payer and a payee,
said payment processor utilizing said currency information and said identification information to determine a transaction restriction level,
said payment processor verifying that said identification information meets a threshold for said transaction restriction level,
said payment processor receiving payment in said payer fiat-currency and initiating a transaction to convert said payer fiat-currency amount into a crypto-currency amount,
said payment processor converting said crypto-currency amount into said payee fiat-currency, and
said payment processor initiating a transfer of said payee fiat-currency amount to said payee.

2. The method of claim 1, further comprising said payment processor determining criteria to be used to select said crypto-currency and selecting said crypto-currency.

3. A method of electronic commerce payments comprising;
a payment processor receiving currency information and identification information,
said currency information comprising a payer fiat-currency and a payee fiat-currency,
said identification information comprising information verifying the identify of a payer and a payee,
said payment processor utilizing said currency information and said identification information to determine a transaction restriction level,
said payment processor verifying that said identification information does not meet a threshold for said transaction restriction level and augmenting said identification information to meet said threshold for said transaction restriction level,
said payment processor receiving payment in said payer fiat-currency and initiating a transaction to convert said payer fiat-currency amount into a crypto-currency amount,
said payment processor converting said crypto-currency amount into said payee fiat-currency, and
said payment processor initiating a transfer of said payee fiat-currency amount to said payee.

4. The method of claim 3, further comprising said payment processor determining criteria to be used to select a crypto-currency and selecting said crypto-currency.

5. The method of claim 3, further comprising said payment processor augmenting said identification information comprises verifying the identity of said payer with a first portion of information provided by said payer and a second portion of information provided by said payee.

6. The method of claim 3, further comprising said payment processor augmenting said identification information comprises verifying the identity of said payee with a first portion of information provided by said payer and a second portion of information provided by said payee.

7. A method of electronic commerce payments comprising;
a payment processor receiving currency information and identification information,
said currency information comprising a payer fiat-currency and a payee fiat-currency,
said identification information comprising information comprising a payer trusted level and a payee trusted level,
said payment processor utilizing said currency information and said identification information to determine a transaction restriction level,
said payment processor verifying that said payer trusted level and said payee trusted level meet a threshold for said transaction restriction level,
said payment processor receiving payment in said payer fiat-currency and initiating a transaction to convert said payer fiat-currency amount into a crypto-currency amount,
said payment processor converting said crypto-currency amount into said payee fiat-currency,
said payment processor initiating a transfer of said payee fiat-currency amount to said payee.

8. A method of currency transactions over a network using a payment processor server comprising;
providing a payer user interface to receive currency information and identification information, said currency information comprising a payer fiat-currency and a payee fiat-currency, said identification information comprising information verifying the identify of a payer and a payee,
utilizing said currency information and said identification information to determine a transaction restriction level,
verifying that said identification information meets a threshold for said transaction restriction level,
receiving payment in said payer fiat-currency and initiating a transaction to accessing a first exchange to convert said payer fiat-currency amount into a crypto-currency amount,
accessing a second exchange and converting said crypto-currency amount into said payee fiat-currency, and
initiating a transfer of said payee fiat-currency amount to said payee.

9. A method of currency transactions over a network using a payment processor server comprising;
providing a payer user interface to receive currency information and identification information, said currency information comprising a payer fiat-currency and a payee fiat-currency, said identification information comprising information verifying the identify of a payer and a payee,
receiving over said network said currency information and identification information by said payment processor server, said payment processor server comprising a processor and a memory that stores said currency information and identification information, wherein said processor
compares said currency information and said identification information against a threshold to determine a transaction restriction level,
verifies that said identification information meets a threshold for said transaction restriction level,
receives payment in said payer fiat-currency and initiates a network transaction to access a first exchange to convert said payer fiat-currency amount into a crypto-currency amount,
accesses a second exchange and converting said crypto-currency amount into said payee fiat-currency, and
initiates a second network transfer of said payee fiat-currency amount to said payee.
